(19) United States
(12) Patent Application Publication
(10) Pub. No.: US 2016/0048913 A1
(43) Pub. Date: Feb. 18, 2016

(54) Systems and Methods for Assigning a Variable Length Bank Identification Number

(71) Applicant: MASTERCARD INTERNATIONAL INCORPORATED, Purchase, NY (US)

(72) Inventors: Suman Rausaria, Ballwin, MO (US); Michael Rethorn, Chesterfield, MO (US); Saurabh Mehta, Singapore (SG)

(21) Appl. No.: 14/460,601

(22) Filed: Aug. 15, 2014

(51) Int. Cl. G06Q 40/02; G06Q 20/10

(52) U.S. Cl. CPC G06Q 40/02; G06Q 20/10

(57) ABSTRACT

Systems and methods for use in assigning bank identification numbers (BINs) are disclosed. One exemplary method includes identifying a payment account demand for an issuer. The payment account demand is associated with an anticipated number of primary account numbers (PANs) for the issuer, each PAN having a PAN length. The method further includes selecting a BIN length for the issuer based on the payment account demand where the BIN length being less than the PAN length, assigning a BIN to the issuer where the BIN has the BIN length, and appending the BIN to a BIN directory. The BIN is associated with the issuer. The BIN is different than each other BIN in the BIN directory.

### FIELD

The present disclosure generally relates to systems and methods for use in assigning a bank identification number (BIN) to an issuer, where the BIN includes a length independent of the number of payment accounts anticipated to be assigned by the issuer.

### BACKGROUND

This section provides background information related to the present disclosure which is not necessarily prior art.

Payment accounts are known. Payment accounts permit consumers to transact with merchants for goods and services, using the credit and/or balance associated with the payment accounts. A payment account number is identified by a primary account number, or PAN, which is assigned to the consumer by the issuer of the payment account. The PAN is used in completed transactions to ensure transactions for a consumer are posted to his/her payment account. The PAN consists of a bank identification number, or BIN, an account identifier and a check digit, which is used to verify the validity of the PAN. The standard BIN is known to be a fixed, 6-digit number, which includes a major industry identifier, or IIN, as its leading digits. The BIN is unique to an issuer, and used to, among other things, route authorization requests in a payment network to that issuer.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in processing payment transactions.

FIG. 2 is a block diagram of a computing device that may be used in the exemplary system of FIG. 1.

FIG. 3 is an exemplary method for use in assigning a BIN to an issuer.

FIG. 4 is an exemplary method for use in processing transactions to a payment account.

Corresponding reference numerals indicate corresponding parts throughout the several views of the drawings.

### DETAILED DESCRIPTION

Exemplary embodiments will now be described more fully with reference to the accompanying drawings.

Because the BIN of a primary account number, or PAN, has been known to have a standard, fixed length of 6 digits , the number of BINs that may be assigned to issuers is limited. Therefore, payment service providers are limited in the number of BINs, which they are able to assign to issuers of payment accounts. Equally, when a BIN is assigned, an issuer to whom it is assigned is able to issue a large number of PANs, which may be excessive depending on the particular issuer, the size of the issuer, type of portfolio, etc. Simply, for a conventional 16-digit PAN, of which the first 6 digits is a standard BIN, each assigned BIN permits the issuer to assign up to 1 billion unique account numbers. For certain issuers or their portfolio, this is excessive. The systems and methods described herein provide the payment service provider, for example, the ability to vary the length of the BIN, so that the resulting number of possible account numbers is more aligned with the anticipated demand of the issuer. In this manner, a standard 6-digit BIN may be expanded into several BINs, which may then be assigned to various different issuers.

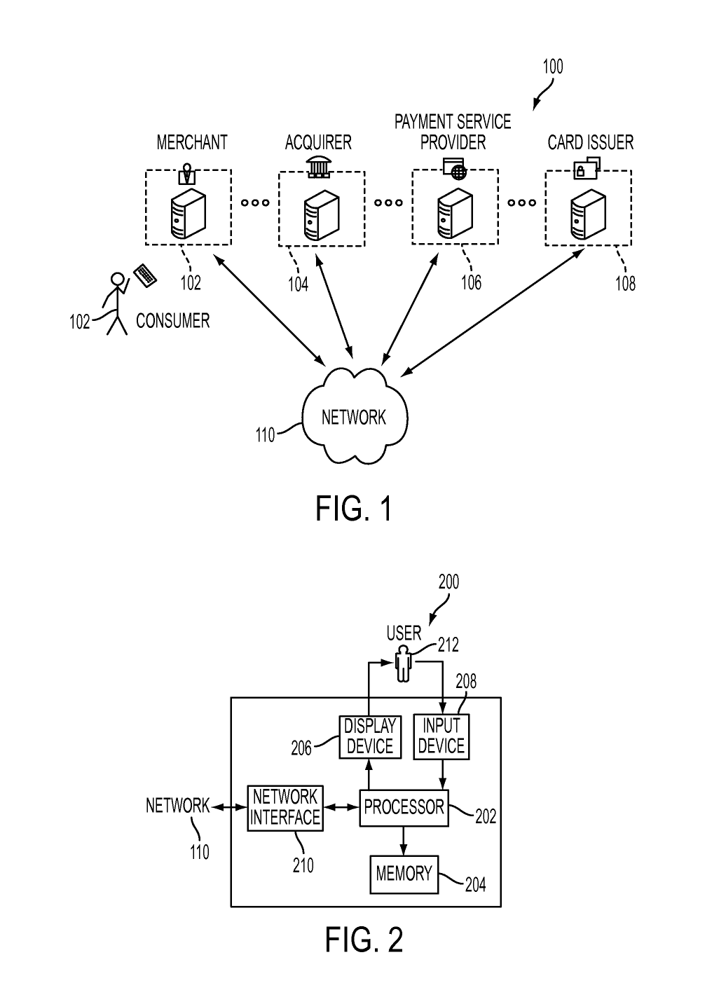

FIG. 1 illustrates an exemplary system 100, in which the one or more aspects of the present disclosure may be implemented. Although, in the described embodiment, components of the system 100 are presented in one arrangement, other embodiments may include the same or different components arranged otherwise, depending, for example, on the manner in which payment transactions are processed, etc.

Referring to FIG. 1, the system 100 generally includes a merchant 102, an acquirer 104 (or merchant bank), a payment service provider 106, and an issuer 108, each coupled to network 110. The network 110 may include, without limitation, a local area network (LAN), a wide area network (WAN) (e.g., the Internet, etc.), a mobile network, and/or another suitable public and/or private network capable of supporting communication among two or more of the components illustrated in FIG. 1, or even combinations thereof. Generally, in this example, at least two networks are included in the network 110. A public network is coupled between the merchant 102 and the acquirer 104, while a private payment network is coupled between the acquirer 104, the payment service provider 106, and the issuer 108.

Each of the merchant 102, the acquirer 104, the payment service provider 106, and the issuer 108 in the illustrated system 100 may be implemented in any one or more computing devices, such as a computing device or multiple computing devices located together, or distributed across a geographic region. For illustration, the system 100 is further described below with reference to an exemplary computing device 200 illustrated in FIG. 2. The system 100, and the components therein, however, should not be considered to be limited to the computing device 200, as different computing devices, and/or arrangements of computing devices may be used in other embodiments.

The computing device 200 may include, for example, one or more servers, workstations, personal computers, laptops, tablets, PDAs, point of sale terminals, smartphones, etc.

As shown in FIG. 2, the exemplary computing device 200 includes a processor 202 and a memory 204 coupled to the processor 202. The processor 202 may include, without limitation, a central processing unit (CPU), a microprocessor, a microcontroller, a programmable gate array, an ASIC, a logic device, or the like. The memory 204 is a computer readable media, which includes, without limitation, random access memory (RAM), a solid state disk, a hard disk, compact disc read only memory (CD-ROM), erasable programmable read only memory (EPROM), tape, flash drive, and/or any other type of volatile or nonvolatile physical or tangible computer-readable media. Memory 204 may be configured to store, without limitation, payment transaction data, BIN directories, payment account demands, and/or other types of data suitable for use as described herein.

In the exemplary embodiment, computing device 200 includes a display device 206 that is coupled to the processor 202. Display device 206 outputs to a user 212 by, for example, displaying and/or otherwise outputting information such as, but not limited to, BIN directories, account numbers, BINs, payment transactions, and/or any other type of data. For example, display device 206 may include, without limitation, a cathode ray tube (CRT), a liquid crystal display (LCD), a light-emitting diode (LED) display, an organic LED (OLED) display, and/or an “electronic ink” display. In some embodiments, display device 206 includes multiple devices. It should be further appreciated that various interfaces (e.g., graphic user interfaces (GUI), or webpages, etc.) may be displayed at computing device 200, and in particular at display device 206, to initiate, complete, and/or transmit one or more BIN requests, etc.

The computing device 200 also includes an input device 208 that receives input from the user 212, such as at the merchant 102, for example. The input device 208 is coupled to the processor 202 and may include, for example, a keyboard, a pointing device, a mouse, a stylus, a touch sensitive panel (e.g., a touch pad or a touch screen, etc.), and/or an audio input device. In some example embodiments, the input device 208 may include a card reader, swipe reader, etc., and/or any other device suitable for obtaining payment transaction information from a payment device. Further, in various exemplary embodiments, a touch screen, such as that included in a tablet, a smartphone, or similar device, behaves as both a display device 206 and input device 208.

The computing device 200 further includes a network interface 210 coupled to the processor 202. The network interface 210 may include, without limitation, a wired network adapter, a wireless network adapter, a mobile telecommunications adapter, or other device capable of communicating to one or more different networks, including the network 110.

Referring again to FIG. 1, the merchant 102, the acquirer 104, the payment service provider 106, and the issuer 108 cooperate, in response to a request from a consumer 112, to complete a payment transaction such as a credit transaction, etc.

As an example, in a credit transaction in the system 100, the merchant 102, often the merchant's computing device 200, reads a payment device (e.g., MasterCard® payment devices, etc.) and transmits an authorization request, which includes a primary account number (PAN) and an amount of the purchase, to the acquirer 104. The acquirer 104, in turn, communicates with the issuer 108 through the payment service provider 106, such as, for example, MasterCard®, for authorization to complete the transaction. In particular, a part of the PAN, i.e., the BIN, identifies the issuer, and permits the acquirer 104 and/or payment service provider 106 to route the authorization request to the particular issuer 108. When the BIN length is 6 digits, as is standard, the acquirer 104 and/or payment service provider 106 handle the authorization, and ultimately the clearing of the transaction, in accordance with known processes. However, when the BIN length is other than 6 digits, i.e., a nonstandard BIN, an indication of the variable length BIN is included in the authorization request and/or transmitted from the merchant separate from the authorization request, based on an indication from the payment device, to indicate the nonstandard BIN. The indication is described in more detail below.

If the issuer 108 accepts the transaction, an authorization reply is provided back to the merchant 102 and the merchant 102 completes the transaction. The transaction is posted to the payment account associated with the consumer 112. The transaction is later settled by and between the merchant 102, the acquirer 104, and the issuer 108. In other exemplary transactions, a transaction may further include the use of a personal identification number (PIN) authorization, or other steps associated with identifying a payment account and/or authenticating the consumer 112, etc. And, in some transactions, the acquirer 104 and the issuer 108 communicate directly, apart the payment service provider 106.

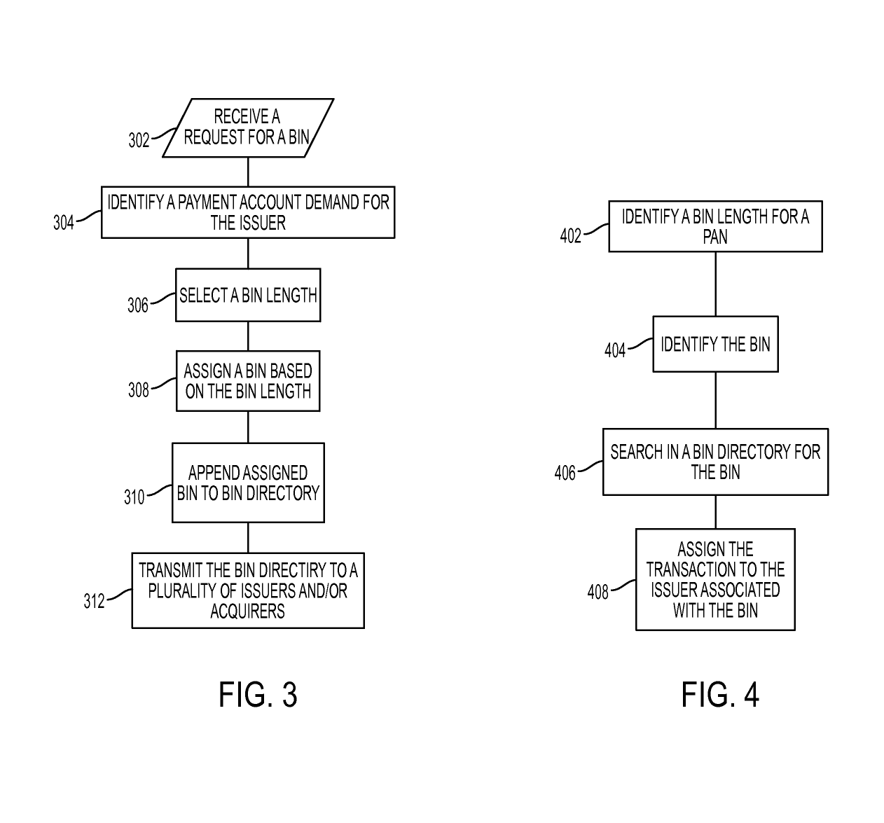

FIG. 3 illustrates an exemplary method 300 for assigning a BIN to an issuer. For purposes of illustration, the exemplary method 300 is described as performed by the payment service provider 106, which includes one or more computing devices 200, as described above. It should be appreciated, however, that the methods described herein may be performed by other entities, including those shown in FIG. 1. Moreover, it should be appreciated that the methods described herein are not limited to the system 100, or computing device 200. And, conversely, the systems and computing devices described herein are not limited to the exemplary method 300.

For purposes of illustration, method 300 is described with reference to a 16-digit PAN. It should be understood that the length of the PAN may be different in a variety of other embodiments. For example, the PAN length may be 12 digits, 15 digits, 18 digits, 19 digits, or more or less digits, etc. Regardless of the length of the PAN, a part of the PAN is referred to as the BIN, which is usually the first part of the PAN. It is standard in the industry to have a fixed, 6-digit BIN, which is used to route transactions, etc., as described above. Although the term “digits” generally refers to numbers, in at least one embodiment, digits may include numbers, letters or a combination of number(s) and letter(s).

Referring to FIG. 3, the issuer 108 transmits a request for a BIN to the payment service provider 106. In turn, the payment service provider 106 receives the BIN request, at 302. The request generally includes the issuer's identification and certain qualifications, including, for example, institution type, revenues, major customer segments, geographic locations, transactions requirements, license agreements, tax conditions, risk management, etc. The request may further include a payment account demand, which is an indication of the number of PANs the issuer 108 anticipates assigning to consumers 112. For example, when the issuer 108 is centralized in a limited, rural region, the issuer 108 may anticipate issuing less than 10,000 payment accounts, thereby requiring less than 10,000 PANs. Alternatively, when the issuer 108 services a larger metropolitan region, or multiple regions, the issuer 108 may anticipate more than 1,000,000 payment accounts, thereby requiring more than 1,000,000 PANs. As indicated above, the payment account demand may be indicated by the issuer 108. Additionally, or alternatively, the payment account demand may be determined by the payment service provider 106, based on for example, the history of the issuer 108, the reach of the issuer 108, the presence of the issuer 108 in one or more regions, or any other data related to the issuer 108 or the payment service provider 106, etc. In at least one embodiment, the issuer 108 and payment service provider 106 cooperate to determine the payment account demand.

Regardless of the whether the payment account demand is received from the issuer 108, or directly determined by the payment service provider 106, the payment service provider 106 identifies the payment account demand, at 304.

At step 306, the payment service provider 106 then selects a BIN length based on the payment account demand associated with the issuer 108. For example, for an issuer that provides a 16-digit PAN, the BIN length may be selected according to TABLE 1 for the particular payment account demand.

TABLE 1

| | | | 8 Digit | 9 Digit | 10 Digit | 11 Digit |
|---|---|---|---|---|---|---|
| | 6 Digit BIN | 7 Digit BIN | BIN | BIN | BIN | BIN |
| No. of | 1,000,000,000 | 100,000,000 | 10,000,000 | 1,000,000 | 100,000 | 10,000 |
| PANs/BIN | | | | | | |

As shown, when the payment account demand associated with the issuer 108 is less than 10,000, the payment service provider 106 may select, for example, a BIN length of 11 digits. Alternatively, when the demand associated with the issuer is 10,000,000, the payment service provider may select, for example, a BIN length of 8 digits. It should be appreciated that the BIN length may be any BIN length based on the demand, and may further be based on other factors, such as, for example, the PAN length, the type of issuer, or other factors that indicate more or less payment accounts may be needed, or other information.

Referring again to FIG. 3, after selecting the BIN length, at 306, the payment service provider 106 assigns a BIN to the issuer 108. The BIN has a length equal to the selected BIN length. In this manner, each assigned BIN is tailored to the demand of the issuer 108. By selecting a BIN length and assigning a BIN having that BIN length, the payment service provider 106 is able to conserve BINs. As shown in Table 2, by varying the BIN length, a greater number of BINs may be issued by the payment service provider 106. For example, the payment service provider 106 may, in one example, issue a BIN “123456” to an issuer 108, such as ABC Bank. Consequently, as shown in Table 1, ABC Bank will be able to issue 1,000,000 payment accounts having unique PANs. If, however, the payment service provider 106 assigns a 7-digit BIN, i.e., “1234560” to ABC Bank, it would be able to issue 9 other BINs (having the root 123456) to the same issuer (as needed) or to other issuers. As should be appreciated from Tables 1 and 2, the payment service provider 106, or other entities, may thus issue BINs having a variety of BIN lengths, i.e., variable length BINs, depending on, for example, the demand of the issuer 108, other factors, etc.

TABLE 2

| BIN Length | No. of BIN |
|---|---|
| 6-digits, 123456 | 1 |
| 7-digits, 123456X | 10 |
| 8-digits, 123456XX | 100 |
| 9-digits, 123456XXX | 1,000 |
| 10-digits, 123456XXXX | 10,000 |
| 11-digits, 123456XXXXX | 100,000 |

After the BIN is assigned to the issuer 108, the BIN is appended to a BIN directory data structure at 310, which is stored in memory 204 of computing device 200. The BIN directory includes at least a listing of the BINs that the payment service provider 106 has issued; each is associated with an issuer. Each BIN in the BIN directory is different than any other BIN in the directory. And, at step 312, the payment service provider 106 transmits the BIN directory to one or more acquirers 104 and/or issuers 108. The BIN directory may be transmitted, in whole or in part, periodically (e.g., daily, weekly, etc.) or intermittently when the BIN directory changes, or as requested by the acquirer 104 and/or issuer 108, for example. In at least one embodiment, a customer profile for the acquirer 104 and/or issuer 108 may indicate the frequency of the transmission of the BIN directory, and whether to transmit the whole directory or parts of the directory (e.g., only updates to the BIN directory, etc.). In one further embodiment, the acquirer 104 and/or issuer 108 retrieves the BIN directory from the payment service provider 106.

In addition to the BIN, the payment service provider 106 may further select the length of the PAN. Even where the BIN length is increased, in some embodiments, the number of payment accounts that may assigned with the BIN may be substantially preserved if the payment service provider selects a different PAN length. The PAN may be selected based on the payment account demand associated with the anticipated number of PANs and/or the BIN length, or other factors, including, for example, the impact to the acquirer 104, the issuer 108, and the payment network of FIG. 1, generally.

After the BIN is assigned to the issuer 108, and the issuer 108 opens accounts for consumers, which are identified by PANs that include the BIN, the accounts are used to complete transactions. As explained above, when a payment device is presented to fund a transaction, an authorization request is transmitted from the merchant 102 through a payment network to the issuer 108. The authorization request is routed through the payment network based on the BIN. Accordingly, the payment service provider 106, through use of the BIN directory, routes the authorization request to the appropriate issuer 108. Conversely, where the authorization request is handled outside of the payment network, and more specifically, avoids the payment service provider 106, the acquirer 104 has to identify the issuer 108. Likewise, during settlement of transactions, the acquirer 104 often identifies the issuer 108.

FIG. 4 illustrates a method of identifying an issuer, when the BIN is a variable length BIN, or otherwise non-standard. As shown, the acquirer 104 identifies the PAN associated with the transaction as having a BIN, with a BIN length different than the standard 6 digits, at 402. In some embodiments, when a transaction is initiated for a payment account with a non-standard BIN, the payment device used in the transaction may direct the merchant 102, and in particular the merchant's computing device 200, to include indicator data in the authorization request. The indicator may be included in a data field, and indicate simply that the BIN is non-standard, or may indicate that the BIN is a particular length. For example, where the BIN is 9 digits, the indicator may simply indicate non-standard BIN, or may indicate the BIN is 9 digits in length. The indicator may be included at the transaction level, for example, in a data field of an ISO message from the merchant 102 and associated with the transaction. Additionally, or alternatively, the BIN length is identified, by the acquirer 104, from the BIN directory. In one example, the acquirer 104 performs a look-up for each PAN received within the BIN directory, to determine the issuer associated with the BIN (included in the PAN). In such an example, the acquirer 104 may further consult a customer profile, which instructs the acquirer 104 on how to route the transaction and with which issuer 108, for example, to reconcile funds for the transaction.

At 404, the acquirer 104 then identifies the BIN within the authorization request, and at 406, searches in the BIN directory, received from the payment service provider 106, for the issuer 108 associated with the BIN. Once the issuer 108 is identified, the acquirer 104 assigns, at 408, the transaction to the issuer 108. In this manner, the acquirer 104 is then able to transmit the authorization request to the issuer 108 directly, rather than through the payment network if desired. Further, after the transaction is complete, the acquirer 104 attempts to settle the transaction, and potentially multiple transactions, with the issuer 108. Settlement often involves bulking or chunking several transactions together to minimize or reduce the number of fund transfers between the acquirer 104 and the issuer 108. After the BIN length is identified, and the issuer 108 is identified, as described above, each transaction is assigned to the issuer 108, at 408, and then, if appropriate, combined with other transactions for the same issuer 108 for settlement.

It should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) identifying a payment account demand for an issuer, the payment account demand associated with an anticipated number of primary account numbers (PANs) for the issuer, each PAN having a PAN length; (b) selecting a BIN length for the issuer based on the payment account demand, the BIN length being less than the PAN length; (c) assigning a BIN to the issuer, the BIN having the BIN length; (d) appending the BIN to a BIN directory, the BIN being associated with the issuer, wherein the BIN is different than each other BIN in the BIN directory; (e) for a transaction to a payment account, identifying a PAN associated with the transaction as having a BIN with a BIN length different than 6 digits; (f) identifying the BIN; (g) searching in a BIN directory for an issuer associated with the BIN; and (h) assigning the transaction associated with the PAN to the issuer.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more exemplary embodiments disclosed herein may provide all or none of the above mentioned advantages and improvements, and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in assigning a bank identification number (BIN) to an issuer, the method comprising:
identifying a payment account demand for an issuer, the payment account demand associated with an anticipated number of primary account numbers (PANs) for the issuer, each PAN having a PAN length;
selecting a BIN length for the issuer based on the payment account demand, the BIN length being less than the PAN length;
assigning, at a computing device, a BIN to the issuer, the BIN having the BIN length; and
appending, at the computing device, the BIN to a BIN directory, the BIN being associated with the issuer, wherein the BIN is different than each other BIN in the BIN directory.

2. The method of claim 1, wherein the assigned BIN length is greater than 6 digits.

3. The method of claim 2, wherein the PAN length is 16 digits and the BIN length is one of 7 digits, 8 digits, and 9 digits.

4. The method of claim 2, further comprising selecting the PAN length based on at least one of: the payment account demand associated with the anticipated number of PANs and the BIN length.

5. The method of claim 1, further comprising disseminating the BIN directory to a plurality of acquirers.

6. The method of claim 1, further comprising selecting the PAN length; and
wherein the BIN length is selected based on the payment account demand and the PAN length.

7. The method of claim 1, wherein appending the BIN to the BIN directory includes designating the BIN as a nonstandard BIN in the BIN directory.

8. The method of claim 1, further comprising receiving, at the computing device, a request for the BIN, the request including the payment account demand associated with the anticipated number of PANs for the issuer.

9. A system for assigning a bank identification number (BIN) to an issuer, the system comprising:
one or more computing devices for handling BIN requests from multiple issuers, the one or more computing devices including a BIN directory and executable instructions that, when executed, cause the one or more computing devices to:
assign a first BIN having a BIN length, based on a first payment account demand, to a first issuer, the BIN length of the first BIN being other than 6 digits, the first payment account demand indicative of a number of primary account numbers (PANs) anticipated to be issued by the first issuer; and
append the first BIN to the BIN directory, the appended first BIN associated with the first issuer.

10. The system of claim 9, wherein the BIN length is greater than 6 digits.

11. The system of claim 10, wherein the instructions further cause the one or more computing devices to select a PAN length based on at least one of: the BIN length and the payment account demand.

12. The system of claim 10, wherein the instructions, when executed, further cause the one or more computing devices to transmit the BIN directory to at least one acquirer.

13. The system of claim 12, wherein the instructions, when executed, cause the one or more computing devices to periodically disseminate the BIN directory to a plurality of issuers and/or acquirers.

14. The system of claim 9, wherein the instructions, when executed, further cause the one or more computing devices to:
assign a second BIN having a BIN length, based on a second payment account demand, to a second issuer, the BIN length of the second BIN being different than the BIN length of the second BIN; and
append the second BIN to the BIN directory.

15. The system of claim 9, wherein the PAN has a PAN length; and
wherein the PAN length is 16 digits and the BIN length is one of 7 digits, 8 digits, 9 digits, and 10 digits.

16. A computer-implemented method for use in processing transactions to payment accounts, the method comprising:
for a transaction to a payment account, identifying a payment account number (PAN) associated with the transaction as having a bank identification number (BIN) with a BIN length different than 6 digits;
identifying, by a computing device, the BIN;
searching, by the computing device, in a BIN directory stored in memory, for an issuer associated with the BIN; and
assigning, by the computing device, the transaction associated with the PAN to the issuer.

17. The method of claim 16, further comprising receiving an authorization request for the transaction, the authorization request including an indicator of the BIN length; and
wherein identifying the PAN as having a BIN with a BIN length different than 6 digits includes detecting the indicator in the authorization request.

18. The method of claim 17, wherein the indicator specifies a BIN length of one of: 7 digits, 8 digits, 9, digits and 10 digits.

19. The method of claim 17, wherein the indicator specifies the BIN as a variable length BIN.

20. The method of claim 19, further comprising settling the assigned transaction with the issuer.
